(19) United States
(12) Patent Application Publication
(10) Pub. No.: US 2006/0119898 A1
(43) Pub. Date: Jun. 8, 2006

(54) Methods for providing encoded visual borders on a scannable document

(75) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/006,425

(22) Filed: Dec. 7, 2004

(51) Int. Cl. H04N 1/40

(52) U.S. Cl. 358/3.28

(57) ABSTRACT

Information on a document may be encoded using indicia, such as end-to-end line segments, that form one or more visually non-intrusive borders. The coded borders may be decoded from the document using a scanner, such as an optical scanner. The coded borders also serve as a visually non-intrusive way to separate and identify content in the document.

### FIELD OF THE INVENTION

The present invention relates generally to methods for encoding a document, and more particularly, to methods for applying scannable borders on a document, where the borders serve as non-intrusive visual boundaries and may be encoded to identify document content and associate information with the document.

### BACKGROUND OF THE INVENTION

The combination of on-demand printing and optical scanning provides unique capabilities not traditionally presented with the use of conventional paper documents. A document may be quickly printed, modified, and scanned. Once scanned, relevant information from the scanned document image may be extracted for analysis. This may include not only analysis of conventional alphanumeric characters printed on the document, but also of encoded information that a viewer cannot interpret.

On-demand printing and scanning is particularly adept at creating and deciphering encoded documents. Often, it is preferred that a viewer be unable to determine what information is encoded on a document. Encoding may also permit a document to be machine-readable, so that information on or pertaining to the document may be quickly extracted. An illustrative example of such a document is an encoded test. When a large volume of tests are to be graded, it is critical that the test be identified in order to automatically score it. Additionally, information associated with the test may be critical, such as a test-taker's identity. Encoding may also be advantageous where information should be hidden from a viewer, for instance, a test-taker's identity when blind grading is desired.

Barcodes are one of the most widely used schemes to encode documents, and are convenient and efficient, particularly when barcode scanners are available. However, barcodes are often less than ideal when used to identify content. First, barcodes are visually intrusive in that they take significant space on a page but provide no useful information to human readers. Second, barcodes often place extra demand on a printing engine in terms of graphic printing capability. A low end printing engine may not be suitable to print certain barcodes with sufficient quality. Third, a high quality scanner may be required to recreate printed barcodes with sufficient quality for decoding.

Therefore, what is needed are efficient and reliable ways to encode and extract information on a document, where the encoded information is visually non-intrusive and accurate despite placing less demand on printers and scanners.

### BRIEF SUMMARY OF THE INVENTION

The present invention encodes information on a document using indicia that forms one or more visually non-intrusive borders on a document. The coded borders may be recognized and decoded from the document using a scanner, such as an optical scanner. The coded borders may also serve as a visually non-intrusive way to separate and identify content in the document.

According to one embodiment of the present invention, there is disclosed a method of providing coded borders. The method includes providing a page having at least one border, where the at least one border includes encoded information detectable by an optical scanner, and where the at least one border includes at least two line segments substantially linearly juxtaposed.

According to one aspect of the invention, the at least two line segments include line segments of at least two different lengths. According to another aspect of the invention, the step of providing a page further includes providing a page having at least one edge, where the at least one border is substantially contiguous with the at least one edge. According to yet another aspect of the invention, the step of providing a page may also include providing a page having at least one edge, where the at least one border is contiguous with substantially the entire length of the at least one edge.

According to another aspect of the invention, the step of providing a page may also include providing a page having at least two edges, where the at least one border is substantially contiguous with the at least two edges. The step of providing a page may also include providing a page having at least four edges, where the at least one border is substantially contiguous with the at least four edges. The at least one border may also be a continuous, uninterrupted border. According to yet another aspect of the invention, the at least one border may include a first border and a second border, with the second border located entirely within an interior area defined by the first border.

According to another embodiment of the invention, there is disclosed a method of coding a sheet using indicia. The method includes printing, on a page, indicia detectable by an optical scanner, where the indicia includes a coded pattern that forms a substantially linear border.

According to one aspect of the invention, the method further includes the step of providing a page having a plurality of edges, and the step of printing further includes printing the indicia on the page at a location substantially contiguous to at least one edge of the plurality of edges. According to another aspect of the invention, the step of printing may include printing, on the page, indicia comprising at least two different markings. The at least two different markings may be linearly juxtaposed. Furthermore, the at least two different markings may include line segments having different lengths. According to yet another aspect of the invention, the indicia may be continuous along at least two of the plurality of edges of the page. Additionally, the substantially linear border may be a continuous an uninterrupted border.

According to yet another embodiment of the invention, there is disclosed a method of encoding a sheet. The method includes printing at least one coded pattern on a page, where the at least one coded pattern forms a substantially linear border.

According to one aspect of the invention, the method may also include the step of scanning the page to identify the at least one coded pattern. The method may further include the step of decoding the at least one coded pattern. According to another aspect of the invention, the step of printing further includes the step of printing the at least one coded pattern on the page, where the at least one coded pattern forms a second substantially linear border. According to yet another aspect of the invention, the page may include at least two edges, and the step of printing may include printing, a continuous at least one coded pattern contiguous to the at least two edges.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an illustrative linear digital coding scheme using line segments, according to an exemplary embodiment of the present invention.

FIG. 2 shows an illustrative encoded document having encoded borders, according to an exemplary embodiment of the present invention.

FIG. 3 shows an illustrative encoded document with two layers of encoded borders, according to an exemplary embodiment of the present invention.

FIG. 4 shows illustrative borders that may be used to encode documents using methods of the present invention.

FIG. 5 is a block diagram flow chart identifying an exemplary process for encoding a sheet with indicia, according to an exemplary embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As described in detail below, the present invention uses coded borders to encode information on a document such as a page, sheet or form. For instance, in use on a test paper, the coded borders may identify a student, class, school, and page number. The coded borders may be recognized and decoded from the document using a scanner, such as an optical scanner. The coded borders may also serve as a visually non-intrusive way to separate and identify content in the document.

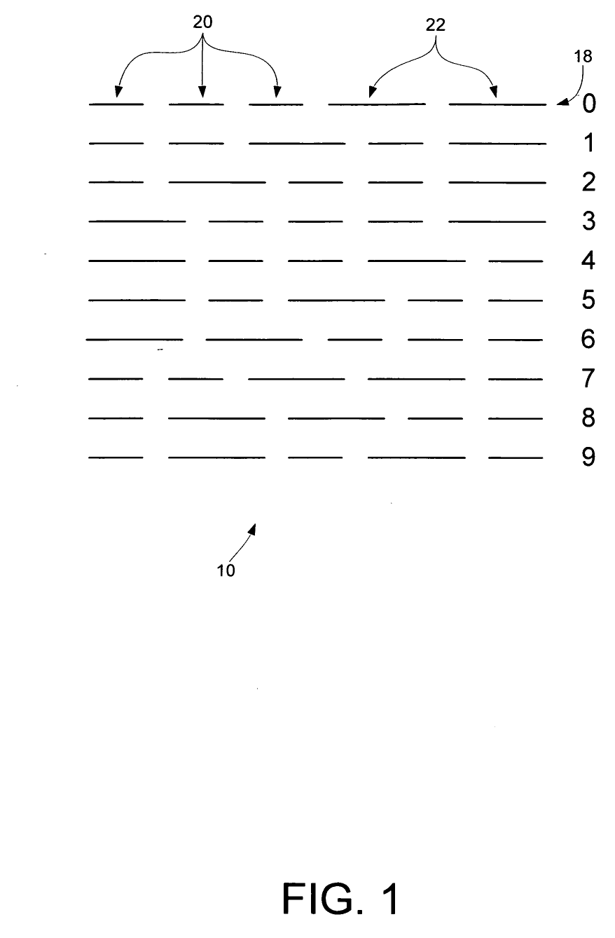

FIG. 1 shows an illustrative digital coding scheme 10, according to an exemplary embodiment of the present invention. The digital coding scheme 10 of FIG. 1 uses line segments of two different lengths, including a short line segment 20 and a long line segment 22. The short and long line segments 20, 22 may be ordered to represent different numerals. For instance, three short line segments 20 followed by two long line segments 22 represents the number 0 18 in the digital coding scheme 10. The simple combination of three short segments 20 and two long segments 22 are used in the digital coding scheme 10 of FIG. 1 to represent numerals 0 through 9. As illustrated, the line segments representing each numeral 0 through 9 are linearly juxtaposed, such that the line segments corresponding to each numeral form a dashed line.

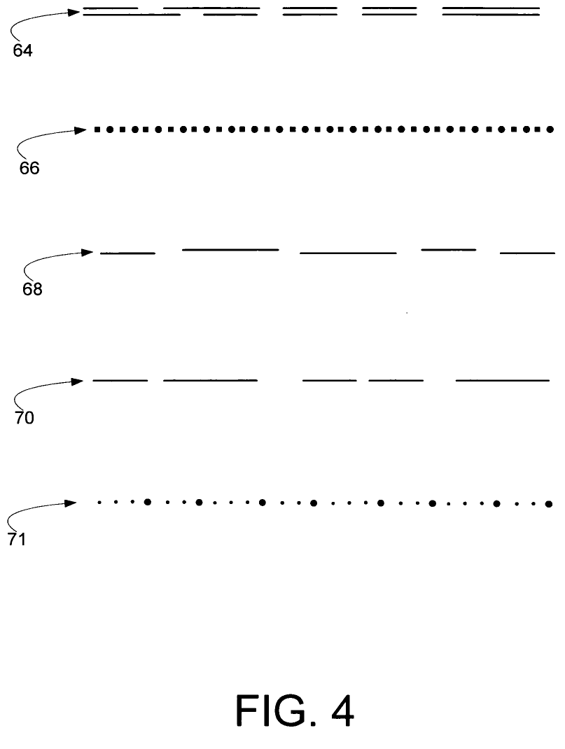

It will be appreciated by one of ordinary skill in the art that the digital coding scheme 10 of FIG. 1 is a simple illustrative encoding scheme, and that many alternative coding schemes using linearly juxtaposed line segments may be implemented depending on the amount of information to be encoded. For instance, rather than encoding simple numerals, as in FIG. 1, a more sophisticated scheme may be used to encode a greater amount of information. According to one embodiment, a greater amount of information may be encoded using a larger number of line lengths and/or different spacing between adjacent line segments. For instance, to increase coding capability, if five different differentiable lengths of line segments are used, a five line segment permutation yields 5!, or 120 codes. A greater amount of information may also be encoded using a larger number of combinations of line lengths. It will be appreciated that using a digital coding scheme having linearly juxtaposed line segments permits a large amount of information to be encoded. For instance, any information codable by various barcode standards, such as UPC and PostNet, may be coded using linearly juxtaposed line segments. With a sufficient number of line segment lengths, and combinations thereof, any combination of numbers, letters, and/or characters may be encoded. Additional techniques for encoding borders are discussed with respect to FIG. 4, below.

It will be appreciated by one of ordinary skill in the art that a digital coding scheme using linearly juxtaposed line segments like the one described with respect to FIG. 1 may also include start and stop line segment combinations, as are well known in the art, which indicate the starting point and ending point of coded information. For instance, the start and stops may be defined by combinations of specified line segments. The length of the spacing between the line segments and/or the thickness of line segments may also be used to identify start and stops. A digital coding scheme using linearly juxtaposed line segments, such as the linear digital coding scheme 10 of FIG. 1 may also utilize a check digit or checksum character represented by one or more line segments. As is well known in the art, the check digit or checksum character may be used to verify that the scan of the linear digital coding scheme has been performed correctly.

Because digital coding schemes are placed on a document that may be viewed by a person and scanned, digital coding schemes using line segments should include line segments having adequate width and length both for visual pleasantness and to provide sufficient density for a scanner such as an optical scanner. This may depend on the resolution of the printer to print the lines or indicia and the resolution of the scanner used to generate a digital image of a document, though current typical document digital printing and scanning may distinguish between pixels representing lines or indicia on the scale of 1/150 inch. According to a preferred embodiment, the length of each line segment should be sufficiently digitally differentiable after typical printing and/or scanning quality degradation. Each line segment may also be sufficiently minimized in length to hide clues from a human reader and for visual homogeneity and pleasantness. Furthermore, to make a coding scheme more tolerable to printing and scanning, the line segments may be proportional to the total length of a border which the line segments construct.

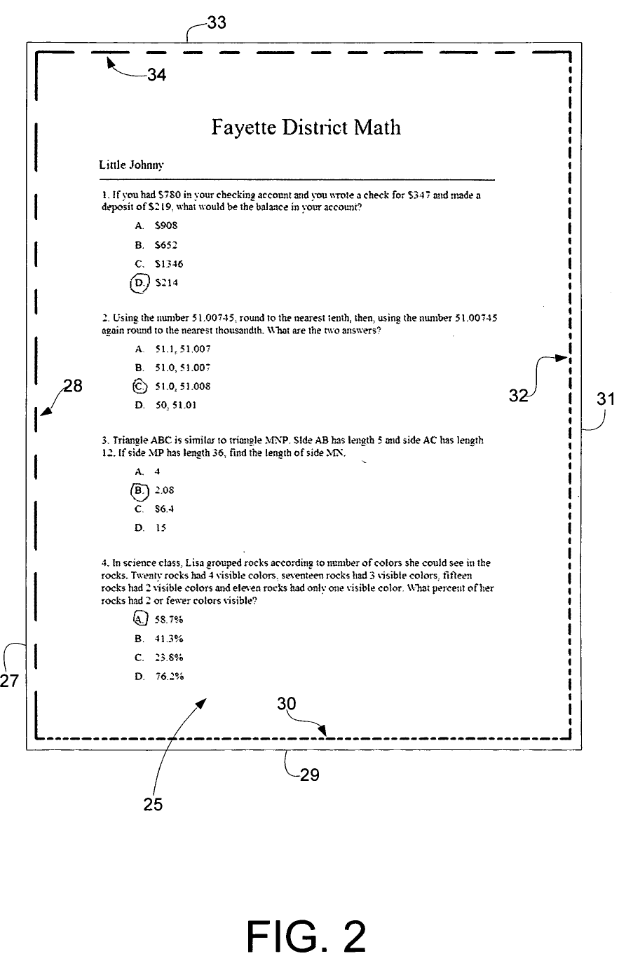

Next, FIG. 2 shows an illustrative coded test sheet 25 having coded borders 28, 30, 32, 34, according to an exemplary embodiment of the present invention. The coded borders 28, 30, 32, 34 each include linearly juxtaposed line segments of different lengths. The coded borders 28, 30, 32, 34 are positioned substantially contiguous with the four edges 27, 29, 31, 33 of the test sheet 25. Additionally, the coded borders 28, 30, 32, 34 extend substantially the entire length of each side, or each edge, of the test sheet 25. It will be appreciated that each of coded borders 28, 30, 32, 34 may each utilize its own combination of line segments, such that each coded border 28, 30, 32, 34 includes encoded information. As an illustrative example, coded borders 28, 30, 32, 34 on the test sheet 25 of FIG. 2 may represent, respectfully, coded information including a student ID, class ID, test ID, and page number.

The coded borders 28, 30, 32, 34 in the illustrative example of FIG. 2 collectively create a single, continuous border running uninterrupted around the entire test sheet 25. As referenced herein, it should be appreciated that a border may represent a single group of line segments forming a dashed line, such as each of the respective coded borders 28, 30, 32, 34, or alternatively, two or more of such groups of line segments, such as a single, continuous border including all of the coded borders 28, 30, 32, 34. According to the amount of information to be coded, and based on the specific application in which they are used, borders do not have to exist on every side of a document. For instance, borders may exist only along the top and bottom edges of a document. Furthermore, it will be appreciated that each border does not have to utilize a different combination of line segments. For instance, when only a small amount of coded information is required, one or more borders on a single page may utilize the same combination of line segments to provide the page with a continuous border though only a border along one side is required to code information. Thus, the same amount of information could be coded with a single border contiguous with one edge of a document or with a continuous border running uninterrupted around an entire document.

A digital coding scheme using linearly juxtaposed line segments may be flexible depending on the specific application and the amount of information desirable to be coded. For some documents a simple numerical coding scheme may be sufficient. For others, a substantial amount of information may be coded. For instance, where a test is printed and scanned at a school, such as in a classroom, only a student ID, test ID and page number may be needed to be coded on a test page. On the other hand, if a test is to be scanned and graded at a remote location, then the school ID and other information may be required to identify the test and to avoid potential confusions with other documents.

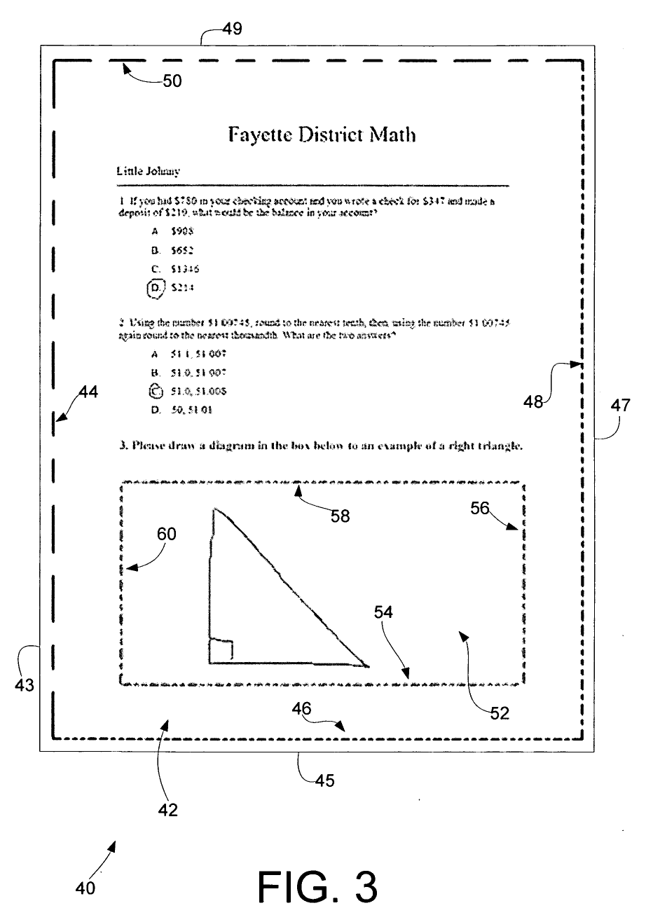

FIG. 3 shows an encoded document with two layers of encoded continuous borders, according to an exemplary embodiment of the present invention. Like the illustrative coded test sheet 25 of FIG. 2, the illustrative coded test sheet 40 of FIG. 3 includes coded borders 44, 46, 48, 50 positioned substantially contiguous with the four edges 43, 45, 47, 49 of the test sheet 40. The coded borders 44, 46, 48, 50 each include linearly juxtaposed line segments of different lengths and span substantially the entire length of each side, or each edge, of the test sheet 40. Like the illustrative example of FIG. 2, each of coded borders 44, 46, 48, 50 may utilize its own combination of line segments, such that each coded border 44, 46, 48, 50 includes encoded information. The coded borders 44, 46, 48, 50 collectively form a continuous outer border that runs uninterrupted around the outside of the test sheet 40. The test sheet 40 shown in FIG. 3 also includes four interior borders 54, 56, 58, 60 that collectively form a continuous inner border that defines an area 52 located entirely within an area 42 defined by the continuous outer border. Like the coded borders 44, 46, 48, 50 that are substantially contiguous with the four edges 43, 45, 47, 49 of the test sheet 40, the four interior borders 54, 56, 58, 60 may each encode respective pieces of information depending on the coded pattern formed by the linearly juxtaposed line segments. As shown in the illustrative example of FIG. 3, the continuous inner border may include encoded information pertaining to a specific test problem.

The test sheet 40 shown in FIG. 3 illustrates that unlike barcodes, encoding using linearly juxtaposed line segments may be implemented in hierarchy. A large area defined by borders may enclose an additional, smaller area defined by its own borders. The smaller area may enclose another even smaller area defined by borders. This scheme may be repeated as many times as necessary depending on how many hierarchies of encoding are desired. A hierarchical encoding approach may be useful in many applications. For example, with reference to another illustrative example of a test page, a test page may be encoded with three separate hierarchical borders encoding, respectively, three levels or types of information, such as: 1) district information, school information, and class information; 2) test ID, student ID, and page number; and 3) answer information, comment information. An outer continuous border may encode the first type of information, the middle continuous border may encode the second type of information, and the innermost border may encode the third type of information. Depending on the type of information required, some of the encoded information within the second or third types of information may never need to be decoded. The outer continuous border may also contain information to indicate whether there are further continuous borders within it that should be decoded. Furthermore, the outer continuous border may also contain information to assist the finding of inner continuous borders to make the decoding process more efficient and accurate.

According to another aspect of the present invention, additional information may be encoded using double line borders using parallel sets of linearly juxtaposed line segments. For instance, a double line border such as the illustrative double border 64 shown in FIG. 4 may be used. The use of double line borders may be particularly useful where multiple hierarchies of borders results in the use of a relatively short border that may limit the number of line segments that may be used to encode information. It will be appreciated that any number of borders may also be used, such as three or four separate parallel borders made up of linearly juxtaposed line segments.

FIG. 4 shows illustrative borders that may be used to encode documents using methods of the present invention. Although the present invention has been described with reference to borders generated from linearly juxtaposed line segments having different lengths, it will be appreciated that almost any indicia may be used to form a substantially linear coded pattern. Therefore, a border of the present invention may be generated not only from linearly juxtaposed line segments, or groupings of the same, but also by other indicia creating coded patterns that appear to have a generally linear contour to a viewer. These coded patterns may also be combined into a continuous border contiguous with the edges of a page.

As shown in FIG. 4, two dimensional shapes may be used to form a linear coded pattern, such as a coded border 66 formed of solid circles and squares. Although the circles and squares of the illustrative coded border 66 alternate in sequence, it should be appreciated that any order of shapes, and numbers of shapes, may be used to encode information. Virtually any two dimensional shapes may be used, including outlines of shapes, though it is preferred that the size and variety of shapes are selected to maintain an overall linear contour or effect of a border when it is printed on a document in order to reduce the likelihood that the border is distracting to a reader. According to another aspect of the invention, a coded border 68 according to the present invention may also be generated with one or more line segments (or two dimensional shapes) that are slightly laterally displaced so that they are not linearly juxtaposed. Laterally displacing the line segments allows for another variable that may enable a border to be encoded with a greater amount of information. It is preferred that the lateral displacement be small so that the overall linearity of the border is not substantially impacted.

The spacing between line segments or the spacing between sets of parallel line segments may also be varied to generate a coded border 70. Varied spacing may be combined with one or more of the other coding techniques, such as use of two or more parallel borders, use of two dimensional indicia, and/or use of laterally displaced indicia, to increase the amount of information that may be encoded by a linear border. Yet another technique for forming a linear border is shown in FIG. 4 by a coded border 71 that uses different sizes of two dimensional indicia, such as different sized circles. Like varying the lengths of line segments, varying the size of indicia may be used to generate coded patterns. This method also pertains to any of the previously discussed methods for generating borders. For instance, line segments may be varied in their thickness as well as length. One of ordinary skill in the art will appreciate that any combination of the above-described techniques may be used to generate a border. Furthermore, as with the linearly juxtaposed line segments, start and stops, and/or a check digit or checksum character, may also be implemented with any of the techniques illustrated in FIG. 4.

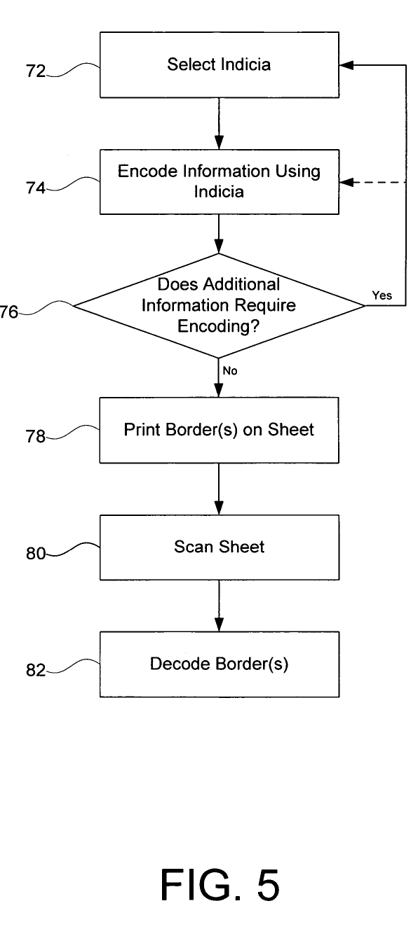

FIG. 5 is a block diagram flow chart identifying an exemplary process for encoding a sheet, according to an exemplary embodiment of the present invention. As shown in FIG. 5, indicia, such as linearly juxtaposed line segments, is initially selected for encoding a document (block 72). Using the indicia, information is encoded (block 74). Different indicia may then be selected to encode additional information, or the same type of indicia used to code previous information may also be used to encode additional information (block 76). When no further information must be encoded, one or more borders are printed on the sheet to be encoded (block 78). Subsequently, the sheet may be scanned (block 80) and the borders may be decoded (block 82).

Decoding borders may require the identification of starts and stops within each border. According to another aspect, decoding may also occur from one edge of the border, with or without the use of starts and stops. Starts and stops can be coded like other alphanumerical symbols according to the specific coding scheme. As stated above, a checksum character or check digit, as are known in the art, may be used to verify that decoding is performed correctly. It should be appreciated that one or more of the blocks illustrated in the block diagram may be performed in a different order than the illustrative process shown in FIG. 5. For instance, the selection of indicia and encoding of information may occur in part after one or more borders are already printed on a sheet.

It should also be appreciated that the encoding and decoding of documents using the method described herein may be implemented by software and/or hardware in communication with a printer and scanner. Because the implementation of the methods described herein using hardware and/or software are well known, the hardware and/or software will not be further described herein. However, it should be appreciated that the encoding and decoding of documents may be fully automated such that a user is not required to select the indicia to encode a document, as the indicia may be preset or randomly selected by hardware and/or software. Likewise, the decoding of a document may also occur automatically, where the hardware and/or software decoding a document receives the encoding scheme used to encode the information on the document, as is well known in the art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing coded borders, comprising:
providing a page having at least one border, wherein the at least one border includes encoded information detectable by an optical scanner, and wherein the at least one border includes at least two line segments substantially linearly juxtaposed.

2. The method of claim 1, wherein the at least two line segments comprise line segments of at least two different lengths.

3. The method of claim 1, wherein the step of providing a page further comprises providing a page having at least one edge, and wherein the at least one border is substantially contiguous with the at least one edge.

4. The method of claim 1, wherein the step of providing a page further comprises providing a page having at least one edge, and wherein the at least one border is contiguous with substantially the entire length of the at least one edge.

5. The method of claim 1, wherein the step of providing a page further comprises providing a page having at least two edges, and wherein the at least one border is substantially contiguous with the at least two edges.

6. The method of claim 1, wherein the step of providing a page further comprises providing a page having at least four edges, and wherein the at least one border is substantially contiguous with the at least four edges.

7. The method of claim 6, wherein the at least one border is a continuous border.

8. The method of claim 1, wherein the at least one border comprises a first border and a second border, the second border being located entirely within an interior area defined by the first border.

9. A method of coding a sheet using indicia, comprising:
printing, on a page, indicia detectable by an optical scanner, wherein the indicia comprises a coded pattern that forms a substantially linear border.

10. The method of claim 9, further comprising the step of providing a page having a plurality of edges, and wherein the step of printing further comprises printing the indicia on the page at a location substantially contiguous to at least one edge of the plurality of edges.

11. The method of claim 10, wherein the step of printing further comprises printing, on the page, indicia comprising at least two different markings.

12. The method of claim 11, wherein the at least two different markings are linearly juxtaposed.

13. The method of claim 11, wherein the at least two different markings comprise line segments having different lengths.

14. The method of claim 11, wherein the indicia is continuous along at least two of the plurality of edges of the page.

15. The method of claim 14, wherein the substantially linear border comprises a continuous border.

16. A method of encoding a sheet, comprising:
printing at least one coded pattern on a page, wherein the at least one coded pattern forms a substantially linear border.

17. The method of claim 16, further comprising the step of scanning the page to identify the at least one coded pattern.

18. The method of claim 17, further comprising the step of decoding the at least one coded pattern.

19. The method of claim 16, wherein the step of printing further comprises the step of printing the at least one coded pattern on the page, where the at least one coded pattern forms a second substantially linear border.

20. The method of claim 16, wherein the page comprises at least two edges, and wherein the step of printing comprises printing a continuous at least one coded pattern contiguous to the at least two edges.
